(19) United States
(12) Patent Application Publication
(10) Pub. No.: US 2023/0038342 A1
(43) Pub. Date: Feb. 9, 2023

(54) Method for producing an active electrode layer for electrochemical reduction reactions by impregnation in a molten medium

(71) Applicant: IFP Energies Nouvelles, Rueil-Malmaison Cedex (FR)

(72) Inventors: Elodie DEVERS, Rueil-Malmaison Cedex (FR); Audrey BONDUELLE-SKRZYPCZAK, Rueil-Malmaison Cedex (FR); Mona Marie OBADIA, Rueil-Malmaison Cedex (FR)

(73) Assignee: IFP Energies Nouvelles, Rueil-Malmaison Cedex (FR)

(21) Appl. No.: 17/783,684

(22) PCT Filed: Dec. 1, 2020
(86) PCT No.: PCT/EP2020/084174

§ 371 Date: Jun. 9, 2022

(30) Foreign Application Priority Data
Dec. 17, 2019 (FR) 1914613

(51) Int. Cl. C25B 11/054; C25B 1/04; C25B 11/052; C25B 11/065; C25B 11/075; C25B 11/091

(52) U.S. Cl. CPC C25B 11/054; C25B 1/04; C25B 11/052; C25B 11/065; C25B 11/075; C25B 11/091

(57) ABSTRACT

A process for preparing a catalytic material of an electrode for electrochemical reduction reactions, said material comprising an active phase based on at least one group VIB metal and an electrically conductive support, which process is carried out according to at least the following steps:

a) bringing water into contact with said electrically conductive support,
b) bringing said wet support into contact with at least one metallic acid hydrate comprising at least one group VIB metal, of which the melting point of said metallic acid hydrate is between 20° C. and 100° C., the weight ratio of said metallic acid to said electrically conductive support being between 0.1 and 4,
c) heating, with stirring, to a temperature between the melting point of said metallic acid hydrate and 100° C.,
d) carrying out a sulfurization step at a temperature of between 100° C. and 600° C.

### TECHNICAL FIELD

The present invention relates to the field of electrodes capable of being used for electrochemical reduction reactions, in particular for the electrolysis of water in a liquid electrolytic medium in order to produce hydrogen.

### PRIOR ART

During recent decades, significant research and development efforts have been carried out to improve the technologies enabling the direct conversion of incident solar radiation into electricity by the photovoltaic effect, the conversion of the energy of moving air masses into electricity by virtue of wind turbines or the conversion of the potential energy of ocean water evaporated and condensed at altitude into electricity by virtue of hydroelectric processes. Due to their intermittent nature, these renewable energies benefit from being upgraded by combining them with an energy storage system to compensate for their lack of continuity. The possibilities considered are batteries, compressed air, reversible dams or energy carriers, such as hydrogen. For the latter, the electrolysis of water is the most advantageous route because it is a clean production method (no carbon emission when it is coupled with a renewable energy source) and provides hydrogen of high purity.

In a water electrolysis cell, the hydrogen evolution reaction (HER) occurs at the cathode and the oxygen evolution reaction (OER) occurs at the anode. The overall reaction is:

H₂O→H₂+½O₂

Catalysts are necessary for both reactions. Different metals have been studied as catalysts for the reaction for producing molecular hydrogen at the cathode. Today, platinum is the most widely used metal because it exhibits a negligible overvoltage (voltage necessary to dissociate the water molecule) compared to other metals. However, the scarcity and cost (>25 k€/kg) of this noble metal are obstacles to the economic development of the hydrogen sector in the long term. This is the reason why, for a number of years now, researchers have been moving toward new platinum-free catalysts that are based on inexpensive metals which are abundant in nature.

The production of hydrogen by electrolysis of water is fully described in the work: “Hydrogen Production: Electrolysis”, 2015, edited by Agata Godula-Jopek. The electrolysis of water is an electrolytic process which breaks down water into gaseous O₂ and H₂ with the help of an electric current. The electrolytic cell is constituted by two electrodes—usually made of inert metal (inert in the potential and pH zone considered), such as platinum—immersed in an electrolyte (in this instance water itself) and connected to the opposite poles of the direct current source.

The electric current dissociates the water (H₂O) molecule into hydroxide (HO⁻) and hydrogen (H⁺) ions: in the electrolytic cell, the hydrogen ions accept electrons at the cathode in an oxidation/reduction reaction with the formation of gaseous molecular hydrogen (H₂), according to the reduction reaction:

2H⁺+2e⁻→H₂.

The particulars of the composition and of the use of the catalysts for the production of hydrogen by electrolysis of water are widely covered in the literature and mention may be made of a review paper bringing together the families of advantageous materials under development in the last ten years: “Recent Development in Hydrogen Evolution Reaction Catalysts and Their Practical Implementation”, 2015, P. C. K. Vesborg et al., where the authors describe sulfides, carbides and phosphides as potential new electrocatalysts.

Among the sulfide phases, dichalcogenides, such as molybdenum sulfide MoS₂, are very promising materials for the hydrogen evolution reaction (HER) due to their high activity, their excellent stability and their availability, molybdenum and sulfur being abundant elements on earth and of low cost.

Materials based on MoS₂ have a lamellar structure and can be promoted by Ni or Co for the purpose of increasing their electrocatalytic activity. The active phases can be used in bulk form when the conduction of the electrons from the cathode is sufficient or else in the supported state, then bringing into play a support of a different nature. In the latter case, the support must have specific properties:
high specific surface area in order to promote the dispersion of the active phase;
very good electron conductivity;
chemical and electrochemical stability under water electrolysis conditions (acidic medium and high potential).

Carbon is the commonest support used in this application. The whole challenge lies in the preparation of this sulfide-based phase on the conductive material.

It is accepted that a catalyst exhibiting a high catalytic potential is characterized by an associated active phase perfectly dispersed at the surface of the support and exhibiting a high active phase content. It should also be noted that, ideally, the catalyst should exhibit accessibility of the active sites with respect to the reactants, in this instance water, while developing a high active surface area, which can result in specific constraints in terms of structure and texture which are inherent to the constituent support of said catalysts.

The usual methods resulting in the formation of the active phase of the catalytic materials for the electrolysis of water consist of depositing precursor(s) comprising at least one group VIB metal, and optionally at least one group VIII metal with the aid of an impregnation solution, on a support by the “dry impregnation” technique or by the “excess impregnation” technique, followed by at least one optional heat treatment to remove the water and by a final step of sulfurization which generates the active phase, as mentioned above.

The prior art shows that researchers have turned toward several methods, including the deposition of Mo precursors in the form of salts or oxides or ammonium heptamolybdate, followed by a step of sulfurization in the gas phase or in the presence of a chemical reducing agent.

By way of example, Chen et al, “Recent Development in Hydrogen Evolution Reaction Catalysts and Their Practical Implementation”, 2011, provide for the synthesis of an MoS₂ catalyst by sulfurization of MoO₃ at different temperatures under an H₂S/H₂ gas mixture with a 10/90 ratio. Kibsgaard et al, “Engineering the surface structure of MoS₂ to preferentially expose active edge sites for electrocatalysis”, 2012, provide for the electrodeposition of Mo on an Si support from a peroxopolymolybdate solution and then for the implementation of a step of sulfurization at 200° C. under an H₂S/H₂ gas mixture with a 10/90 ratio. Bonde et al, “Hydrogen evolution on nano-particulate transition metal sulfides”, 2009, provide for the impregnation of a carbon support with an aqueous ammonium heptamolybdate solution, for drying it in air at 140° C. and then for carrying out a sulfurization at 450° C. under an H₂S/H₂ gas mixture with a 10/90 ratio for 4 hours. Benck et al., “Amorphous Molybdenum Sulfide Catalysts for Electrochemical Hydrogen Production: Insights into the Origin of their Catalytic Activity”, 2012, synthesized an MoS₂ catalyst by mixing an aqueous ammonium heptamolybdate solution with a sulfuric acid solution and then, in a second step, a sodium sulfide solution in order to form MoS₂ nanoparticles.

The patent application (not yet published) filed under national number FR18/72176 by the applicant describes a process for preparing a catalytic material of an electrode for electrochemical reduction reactions, said material comprising an active phase based on at least one group VIB metal and an electrically conductive support, which process is carried out according to at least the following steps:
a step of bringing said support into contact with at least one solution containing at least one precursor of at least one group VIB metal;
a drying step at a temperature below 250° C., without a subsequent calcining step;
a sulfurization step at a temperature of between 100° C. and 600° C.

The preparation processes described above therefore all require an impregnation step using an impregnation solution containing at least one precursor of the active phase.

It appears advantageous to find other means for preparing a catalytic material of an electrode for the production of hydrogen by electrolysis of water, making it possible to obtain new catalytic materials having improved performance qualities.

A completely different preparation route is impregnation in a molten medium. This technique, particularly well described in the publication “Melt Infiltration: an Emerging Technique for the Preparation of Novel Functional Nanostructured Materials”, P. E. de Jongh, T. M. Eggenhuisen, Adv. Mater. 2013, 25, 6672-6690, is based on a single-step process based on the pressureless infiltration by capillary action of a molten liquid into a porous body.

Applied to the field of catalysis, melt impregnation consists in mixing a porous support with a solid metal salt having a relatively low melting point, in particular below its decomposition temperature, then heating the mixture to a temperature above the melting point of said metal salt in order to melt the salt in the support.

This technique is thus distinguished from conventional impregnation by several advantages, in particular by a simplified preparation. Indeed, it does not require the preparation of a solution or a solvent because the metal precursors are used in the form of solids. Similarly, the catalytic material obtained after heating the solid support/salt mixture does not need additional drying steps. In addition, a major advantage of melt impregnation is the fact of being able to obtain, in a single step, a catalytic material with a very high metal content.

However, this technique has the disadvantage of requiring a metal salt having a relatively low melting point, in particular lower than its decomposition temperature. Although such salts exist for group VIII metals, notably in the form of a nitrate salt hydrate based on nickel or cobalt, there does not appear to be any group VIB salts that meet these low melting point criteria. Indeed, the salts based on a group VIB metal tend rather to decompose before reaching their melting point.

In this context, one of the objectives of the present invention is to propose a process for preparing a catalytic material of an electrode for electrochemical reduction reactions based on a group VIB metal prepared by melt impregnation.

### SUMMARY OF THE INVENTION

A first subject of the present invention is a process for preparing a catalytic material of an electrode for electrochemical reduction reactions, said material comprising an active phase based on at least one group VIB metal and an electrically conductive support, the content of group VIB metal being between 4% and 70% by weight expressed as group VIB metal element relative to the total weight of the catalytic material, said process comprising the following steps:

a) bringing water into contact with said electrically conductive support so as to obtain a wet electrically conductive support,
b) bringing said wet electrically conductive support into contact with at least one metallic acid hydrate comprising at least one group VIB metal, of which the melting point of said metallic acid hydrate is between 20° C. and 100° C., in order to form a solid mixture, the weight ratio of said metallic acid to said electrically conductive support being between 0.1 and 4,
c) heating, with stirring, the solid mixture obtained at the end of step b) to a temperature between the melting point of said metallic acid hydrate and 100° C.,
d) carrying out a step of sulfurization of the material obtained at the end of step c) at a temperature of between 100° C. and 600° C.

The applicant has developed a new process for preparing a catalytic material which makes it possible to obtain an electrode which can be used in an electrolytic cell for carrying out an electrochemical reduction reaction, and more particularly which makes it possible to obtain a cathode which can be used in an electrolytic cell for the production of hydrogen by electrolysis of water.

The applicant has in fact observed that the use of a metallic acid hydrate comprising at least one group VIB metal and having a melting point of between 20° C. and 100° C. makes it possible to introduce a group VIB metal into an electrically conductive support by melt impregnation. This makes it possible to obtain a catalytic material having catalytic performances at least as good, or even better, than a catalytic material prepared by impregnation using an impregnation solution with however a simplified preparation and the possibility of loading more group VIB metal.

The metallic acid hydrate, which is in powder form, is mixed with the electrically conductive support (step b), then this solid mixture is heated in order to melt the metallic acid in the support, thus making it possible to obtain the material from step c) which is subsequently subjected to a sulfurization step (step d). However, the acid has the distinctive feature of only melting in the presence of a sufficient partial pressure of water. In other words, it is necessary to keep the water molecules of crystallization to ensure its melting. In order to guarantee a sufficient partial pressure of water, the support is first moistened by water impregnation (step a).

The preparation process according to the invention thus has the advantages of a melt impregnation, notably the absence of any preparation of solution or the use of solvent and the absence of the need for subsequent drying even if a such a step is possible.

In addition, the preparation process according to the invention makes it possible to obtain a catalytic material heavily loaded with group VIB metal having in particular contents of group VIB metal which are not achievable by impregnation using an impregnation solution.

In one embodiment according to the invention, the metallic acid hydrate is chosen from phosphomolybdic acid hydrate, silicomolybdic acid hydrate, molybdosilicic acid hydrate, phosphotungstic acid hydrate and silicotungstic acid hydrate.

In one embodiment according to the invention, said electrically conductive support comprises at least one material chosen from carbon structures of carbon black, graphite, carbon nanotubes or graphene type.

In one embodiment according to the invention, said electrically conductive support comprises at least one material chosen from gold, copper, silver, titanium or silicon.

In one embodiment according to the invention, step b) further comprises bringing into contact with at least one metal salt comprising at least one group VIII metal, of which the melting point of said metal salt is between 20° C. and 100° C., in order to form a solid mixture, the (group VIII metal)/(group VIB metal) molar ratio being between 0.1 and 0.8.

In one embodiment according to the invention, said metal salt is a nitrate salt hydrate or a sulfate salt hydrate. Preferably, said metal salt is chosen from nickel nitrate hexahydrate, cobalt nitrate hexahydrate, iron nitrate nonahydrate, nickel sulfate hexahydrate, cobalt sulfate heptahydrate, iron sulfate heptahydrate, taken alone or as a mixture.

In one embodiment according to the invention, step b) further comprises bringing into contact with phosphoric acid, to form a solid mixture, the phosphorus/(group VIB metal) molar ratio being between 0.08 and 1.

In one embodiment according to the invention, step b) further comprises bringing into contact with an organic compound comprising oxygen and/or nitrogen and/or sulfur, of which the melting point of said organic compound is between 20° C. and 100° C., the organic compound/group VIB metal molar ratio being between 0.01 and 5. Preferably, the organic compound is chosen from maleic acid, sorbitol, xylitol, γ-ketovaleric acid, 5-hydroxymethylfurfural and 1,3-dimethyl-2-imidazolidinone.

In one embodiment according to the invention, before step a) or after step c), an impregnation step is carried out using an impregnation solution and wherein said electrically conductive support or said material obtained at the end of step c) is brought into contact with an impregnation solution comprising a group VIB metal and/or a group VIII metal and/or phosphorus and/or an organic compound comprising oxygen and/or nitrogen and/or sulfur, followed by a step of drying at a temperature below 200° C. and optionally a step of calcining at a temperature above or equal to 200° C. and below or equal to 600° C. under an inert atmosphere or under an oxygen-containing atmosphere. Preferably, the organic compound is chosen from γ-valerolactone, 2-acetylbutyrolactone, triethylene glycol, diethylene glycol, ethylene glycol, ethylenediaminetetraacetic acid (EDTA), maleic acid, malonic acid, citric acid, gluconic acid, dimethyl succinate, glucose, fructose, sucrose, sorbitol, xylitol, γ-ketovaleric acid, dimethylformamide, 1-methyl-2-pyrrolidinone, propylene carbonate, 2-methoxyethyl 3-oxobutanoate, bicine, tricine, 2-furaldehyde (also known under the name furfural), 5-hydroxymethylfurfural (also known under the name 5-(hydroxymethyl)-2-furaldehyde or 5-HMF), 2-acetylfuran, 5-methyl-2-furaldehyde, ascorbic acid, butyl lactate, ethyl 3-hydroxybutanoate, ethyl 3-ethoxypropanoate, 2-ethoxyethyl acetate, 2-butoxyethyl acetate, 2-hydroxyethyl acrylate, 1-vinyl-2-pyrrolidinone, 1,3-dimethyl-2-imidazolidinone, 1-(2-hydroxyethyl)-2-pyrrolidinone, 1-(2-hydroxyethyl)-2,5-pyrrolidinedione, 5-methyl-2(3H)-furanone, 1-methyl-2-piperidinone and 4-aminobutanoic acid.

In one embodiment according to the invention, when the precursor of the catalytic material comprises at least one group VIB metal and at least one group VIII metal, the sulfurization temperature in step d) is between 350° C. and 550° C.

In one embodiment according to the invention, when the precursor of the catalytic material comprises solely a group VIB metal, the sulfurization temperature in step d) is between 100° C. and 250° C. or between 400° C. and 600° C.

Another subject according to the invention relates to an electrode, characterized in that it is formulated by a preparation process comprising the following steps:

1) dissolving at least one ionic conductive polymer binder in a solvent or a solvent mixture;
2) adding at least one catalytic material prepared according to the invention, in powder form, to the solution obtained in step 1) in order to obtain a mixture;
steps 1) and 2) being carried out in any order or simultaneously;
3) depositing the mixture obtained in step 2) on a metallic or metallic-type conductive support or collector.

Another subject according to the invention relates to an electrolysis device comprising an anode, a cathode and an electrolyte, said device being characterized in that one at least of the anode or of the cathode is an electrode according to the invention.

Another subject according to the invention relates to the use of the electrolysis device according to the invention in electrochemical reactions.

### DETAILED DESCRIPTION OF THE INVENTION

### Definitions

Subsequently, the groups of chemical elements are given according to the CAS classification (CRC Handbook of Chemistry and Physics, published by CRC Press, editor-in-chief D. R. Lide, 81^{st} edition, 2000-2001). For example, group VIII according to the CAS classification corresponds to the metals of columns 8, 9 and 10 according to the new IUPAC classification.

BET specific surface area is understood to mean the specific surface area determined by nitrogen adsorption in accordance with the standard ASTM D 3663-78 drawn up from the Brunauer-Emmett-Teller method described in the periodical The Journal of the American Chemical Society, 60, 309 (1938).

### Preparation Process

A first subject of the present invention is a process for preparing a catalytic material of an electrode for electrochemical reduction reactions, said material comprising an active phase based on at least one group VIB metal and an electrically conductive support, the content of group VIB metal being between 4% and 70% by weight expressed as group VIB metal element relative to the total weight of the catalytic material, said process comprising the following steps:

a) bringing water into contact with said electrically conductive support so as to obtain a wet electrically conductive support,
b) bringing said wet electrically conductive support into contact with at least one metallic acid hydrate comprising at least one group VIB metal, of which the melting point of said metallic acid hydrate is between 20° C. and 100° C., in order to form a solid mixture, the weight ratio of said metallic acid to said electrically conductive support being between 0.1 and 4,
c) heating, with stirring, the solid mixture obtained at the end of step b) to a temperature between the melting point of said metallic acid hydrate and 100° C.,
d) carrying out a step of sulfurization of the material obtained at the end of step c) at a temperature of between 100° C. and 600° C.
Step a): Bringing Water into Contact with the Electrically Conductive Support

According to step a) of the preparation process according to the invention, water is brought into contact with said electrically conductive support so as to obtain a wet electrically conductive support,

This step of moistening the electrically conductive support is necessary in order to be able to melt the metallic acid hydrate in step c). This is because the acid has the distinctive feature of only melting in the presence of a sufficient partial pressure of water. In other words, it is necessary to keep the water molecules of crystallization of the metallic acid hydrate to ensure its melting.

The contacting step a) can be carried out by dry impregnation. The water can for example be poured dropwise onto the support contained in a rotating pan.

According to a variant, the amount of water introduced into the porous support is between 10% and 70%, and preferably between 30% and 50% of its water uptake volume.

Advantageously, after bringing water into contact with the support, the wet electrically conductive support is allowed to mature. Maturation enables the water to homogeneously disperse within the electrically conductive support.

Any maturation stage is advantageously carried out at atmospheric pressure, in a water-saturated atmosphere and at a temperature of between 17° C. and 50° C., and preferably at room temperature. Generally, a maturation time of between ten minutes and forty-eight hours, preferably of between thirty minutes and fifteen hours and particularly preferably between thirty minutes and six hours is sufficient.

Step b): Bringing the Metallic Acid Hydrate into Contact with the Electrically Conductive Support

According to step b) of the preparation process according to the invention, said wet electrically conductive support is brought into contact with at least one metallic acid hydrate comprising at least one group VIB metal, of which the melting point of said metallic acid hydrate is between 20° C. and 100° C., in order to form a solid mixture, the weight ratio of said metallic acid to said electrically conductive support being between 0.1 and 4.

The metallic acid hydrate must have a relatively low melting point, in particular lower than its decomposition temperature. The melting point of the metallic acid hydrate is between 20° C. and 100° C., and preferably between 50° C. and 90° C.

The metallic acid hydrate comprises at least one group VIB metal. The group VIB metal present in the acid is preferentially chosen from molybdenum and tungsten.

The metallic acid hydrate may additionally comprise phosphorus and silicon.

The metallic acid can be an acid of a Keggin-type heteropolyanion.

The metallic acid hydrate is preferably chosen from phosphomolybdic acid hydrate (H₃PMo₁₂O₄₀.28H₂O, melting point T=85° C.), silicomolybdic acid hydrate (H₄SiMo₁₂O₄₀.xH₂O, melting point T=47-55° C.), molybdosilicic acid hydrate (H₆Mo₁₂O₄₁Si.xH₂O, melting point T=45-70° C.), phosphotungstic acid hydrate (H₃PW₁₂O₄₀.28H₂O, melting point T=89° C.), silicotungstic acid hydrate (H₄SiW₁₂O₄₀.xH₂O, melting point T=53° C.).

The weight ratio of said metallic acid hydrate to said electrically conductive support is between 0.1 and 4, preferably between 0.5 and 3.

In this step, the metallic acid hydrate is in solid form, i.e. said electrically conductive support and said metallic acid hydrate are brought into contact at a temperature below the melting point of said metallic acid hydrate. Step b) is preferably carried out at room temperature.

According to step b), said electrically conductive support and the metallic acid hydrate may be brought into contact by any method known to those skilled in the art. Preferably, said electrically conductive support and said metallic acid hydrate are brought into contact with contacting means chosen from convective mixers, drum mixers or static mixers.

Step b) is carried out for a period of between from 5 minutes to 12 hours depending on the type of mixer used, preferably between 10 minutes and 4 hours, and more preferentially still between 15 minutes and 3 hours.

According to a first variant, step b) consists in bringing said wet electrically conductive support into contact with at least one metallic acid hydrate comprising at least one group VIB metal, of which the melting point of said solid metallic acid hydrate is between 20° C. and 100° C., in order to form a solid mixture, the weight ratio of said metallic acid to said porous support being between 0.1 and 4.

Although the addition of other solid compounds on the catalytic material obtained according to the preparation process of the invention after step c) is not necessary to obtain a catalytic activity close to those of the catalytic materials according to the prior art (prepared by impregnation using an impregnation solution), it may be advantageous in certain cases to add other solid compounds to the solid mixture obtained in step b). Such compounds can in particular be a metal salt comprising at least one group VIII metal, phosphoric acid or else an organic compound.

Thus, according to a second variant, step b) further comprises bringing into contact with at least one metal salt comprising at least one group VIII metal, of which the melting point of said metal salt is between 20° C. and 100° C., in order to form a solid mixture with the electrically conductive support and the metallic acid hydrate, the (group VIII metal)/(group VIB metal) molar ratio being between 0.1 and 0.8.

The metal salt must have a relatively low melting point, in particular lower than its decomposition temperature. The melting point of the metal salt is between 20° C. and 100° C., and preferably between 40° C. and 60° C.

The metal salt comprises at least one group VIII metal. The group VIII metal present in the salt is preferentially chosen from nickel, cobalt and iron.

Preferably, the metal salt is hydrated. Preferably, the metal salt is a nitrate salt hydrate or a sulfate salt hydrate. Preferably, the metal salt is chosen from nickel nitrate hexahydrate (Ni(NO₃)₂.6H₂O, melting point T=56.7° C.), cobalt nitrate hexahydrate (Co(NO₃)₂.6H₂O, melting point T=55.0° C.), iron III nitrate hydrate (Fe(NO₃)₃.9H₂O, melting point T=47.2° C.), nickel sulfate (NiSO₄.6H₂O, melting point T=53° C.), cobalt sulfate (CoSO₄.6H₂O, melting point T=96.8° C.), iron sulfate (FeSO₄.7H₂O, melting point T=56° C.), taken alone or as a mixture.

The (group VIII metal)/(group VIB metal) molar ratio is generally between 0.1 and 0.8, preferably between 0.15 and 0.6.

Preferably, the combination of the metals nickel-molybdenum, cobalt-molybdenum, nickel-tungsten, nickel-molybdenum-tungsten and nickel-cobalt-molybdenum is chosen and very preferably the active phase consists of cobalt and molybdenum, nickel and molybdenum, nickel and tungsten or a nickel-molybdenum-tungsten combination.

It is well known that it is advantageous to add phosphorus to catalytic materials based on group VIB metal and/or group VIII metal. Specifically, phosphorus does not have any catalytic character but increases the catalytic activity of the active phase by the formation of heteropolyanions which increases the dispersion of the elements at the surface of the support.

When phosphomolybdic acid hydrate or phosphotungstic acid hydrate is used as metallic acid hydrate, phosphorus is introduced into the catalytic material with the metallic acid hydrate. In the case of phosphomolybdic acid hydrate, the P/Mo ratio is 0.08. In the case of phosphotungstic acid hydrate, the P/W molar ratio is 0.08.

When it is desired to increase the P/(group VIB metal) molar ratio to ultimately increase the catalytic activity, it is possible to add a phosphorus compound in solid form, notably phosphoric acid, to the electrically conductive support/metallic acid hydrate mixture. Phosphoric acid has a melting point of 42° C.

Thus, according to a third variant, step b) further comprises bringing into contact with phosphoric acid, in order to form a solid mixture with the electrically conductive support and the metallic acid hydrate, and optionally the metal salt comprising at least one group VIII metal.

The phosphorus/(group VIB metal) molar ratio is generally between 0.08 and 1, preferably between 0.1 and 0.9 and very preferably between 0.15 and 0.8.

The addition of an organic compound to the catalysts in order to improve their activity has been recommended by those skilled in the art, notably for catalysts which have been prepared by impregnation using an impregnation solution followed by drying without subsequent calcination. These catalysts are often referred to as “additivated dried catalysts”. The introduction of an organic compound makes it possible to increase the dispersion of the active phase. An organic compound may also be added in the preparation process according to the invention when the organic compound is in solid form.

Thus, according to a fourth variant, step b) further comprises bringing into contact with an organic compound comprising oxygen and/or nitrogen and/or sulfur, of which the melting point of said organic compound is between 20° C. and 100° C., in order to form a solid mixture with the electrically conductive support and the metallic acid hydrate, and optionally the metal salt comprising at least one group VIII metal and phosphoric acid.

Generally, the organic compound is chosen from a compound including one or more chemical functions chosen from carboxyl, alcohol, thiol, thioether, sulfone, sulfoxide, ether, aldehyde, ketone, ester, carbonate, amine, nitrile, imide, oxime, urea and amide functions or else compounds including a furan ring or else sugars.

Among the organic compounds comprising oxygen and/or nitrogen and/or sulfur and having a melting point of between 20° C. and 100° C., maleic acid, sorbitol, xylitol, γ-ketovaleric acid, 5-hydroxymethylfurfural (also known as 5-(hydroxymethyl)-2-furaldehyde or 5-HMF) or 1,3-dimethyl-2-imidazolidinone will preferably be chosen.

The organic compound/group VIB metal molar ratio is between 0.01 and 5 mol/mol, preferably between 0.05 and 3 mol/mol, preferably between 0.05 and 2 mol/mol and very preferably between 0.1 and 1.5 mol/mol.

Step c): Heating with Stirring

According to step c) of the preparation process according to the invention, the solid mixture obtained at the end of step b) is heated with stirring to a temperature between the melting point of said metallic acid hydrate and 100° C.

Step c) is advantageously carried out at atmospheric pressure. Step c) is generally carried out for between 5 minutes and 12 hours, preferably between 5 minutes and 4 hours.

According to step c), the stirring (mechanical homogenization) of the mixture can be carried out by any method known to those skilled in the art. Preferably, use will be made of convective mixers, drum mixers or static mixers.

More preferentially still, step c) is carried out by means of a drum mixer, the rotational speed of which is between 4 and 70 revolutions/minute, preferably between 10 and 60 revolutions/minute.

After step c), a material is obtained which comprises an electrically conductive support and at least one group VIB metal in metallic acid hydrate form.

### Drying Step (Optional)

After the heating step c), the material may be subjected to a drying step at a temperature below 200° C., advantageously between 100° C. and less than 200° C., preferably between 50° C. and 180° C., more preferably between 70° C. and 150° C., very preferably between 75° C. and 130° C.

As a general rule, the drying temperature of the step is higher than the heating temperature of step c). Preferably, the drying temperature of the step is at least 10° C. higher than the heating temperature of step c).

The drying step is preferentially carried out under an inert atmosphere.

The drying step can be carried out by any technique known to those skilled in the art. It is advantageously carried out at atmospheric pressure or at reduced pressure. Preferably, this step is carried out at atmospheric pressure. It is advantageously carried out in a crossed bed using a hot inert gas. Preferably, when the drying is carried out in a fixed bed, the gas used is an inert gas, such as argon or nitrogen. Very preferably, the drying is carried out in a flow-through bed in the presence of nitrogen. Preferably, the drying step has a duration of between 5 minutes and 4 hours, preferably between 30 minutes and 4 hours and very preferably between 1 hour and 3 hours.

According to one variant, at the end of the drying step, a dried material is obtained, which will be subjected to a sulfurization step d).

The drying step may notably be carried out when an organic compound is present. In this case, the drying is preferably carried out so as to preferably retain at least 30% by weight of the organic compound introduced; preferably, this amount is greater than 50% by weight and more preferably still greater than 70% by weight, calculated on the basis of the carbon remaining on the catalyst. The remaining carbon is measured by elemental analysis according to ASTM D5373.

### Calcination Step (Optional)

According to another variant, at the end of the drying step, a calcining step is carried out at a temperature of between 200° C. and 600° C., preferably of between 250° C. and 550° C., in an inert atmosphere (nitrogen for example). The duration of this heat treatment is generally between 0.5 hour and 16 hours, preferably between 1 hour and 5 hours. After this treatment, the catalytic material no longer contains or contains very little organic compound when it has been introduced. However, the introduction of the organic compound during its preparation has made it possible to increase the dispersion of the active phase, thus leading to a more active catalytic material.

When an organic compound is present, whether it is introduced by melt impregnation or by impregnation using an impregnation solution (see below), the catalytic material is preferably not subjected to a calcination.

### Impregnation Step Using an Impregnation Solution Via Post-Impregnation (Optional)

According to one variant, it may be advantageous in certain cases to add, to the material obtained according to step c) of the preparation process according to the invention, or to the material obtained after the optional drying step or after the optional calcining step, at least one of the additional metal precursors by impregnation using an impregnation solution (conventional post-impregnation). It is also possible to add phosphorus or an organic compound.

This conventional impregnation step has the advantage of being able to use metal precursors or organic compounds which are not accessible via the melt technique (because they are in liquid form or have too high a melting point).

Thus, according to one variant, the heating step c), or the optional drying step or the optional calcining step, can be followed by an impregnation step using an impregnation solution and in which said catalyst is brought into contact with an impregnation solution comprising a group VIB metal and/or a group VIII metal and/or phosphorus and/or an organic compound comprising oxygen and/or nitrogen and/or sulfur.

In this case, the group VIB metal, when it is introduced, is preferentially chosen from molybdenum and tungsten. The group VIII metal, when it is introduced, is preferentially chosen from cobalt, nickel and the mixture of these two metals. Preferably, the combination of the metals nickel-molybdenum, cobalt-molybdenum, nickel-tungsten, nickel-molybdenum-tungsten and nickel-cobalt-molybdenum is chosen and very preferably the active phase consists of cobalt and molybdenum, nickel and molybdenum, nickel and tungsten or a nickel-molybdenum-tungsten combination.

The group VIB metal introduced and/or the group VIII metal introduced may be identical to or different from the metals already present in the material resulting from step c).

Use may be made, by way of example, among the sources of molybdenum, of the oxides and hydroxides, molybdic acids and salts thereof, in particular the ammonium salts, such as ammonium molybdate, ammonium heptamolybdate, phosphomolybdic acid (H₃PMo₁₂O₄₀), and salts thereof, and optionally silicomolybdic acid (H₄SiMo₁₂O₄₀) and salts thereof. The sources of molybdenum can also be any heteropolycompound of Keggin, lacunary Keggin, substituted Keggin, Dawson, Anderson or Strandberg type, for example. Use is preferably made of molybdenum trioxide and the heteropolycompounds of Keggin, lacunary Keggin, substituted Keggin and Strandberg type.

The tungsten precursors which can be used are also well known to a person skilled in the art. For example, use may be made, among the sources of tungsten, of the oxides and hydroxides, tungstic acids and salts thereof, in particular the ammonium salts, such as ammonium tungstate, ammonium metatungstate, phosphotungstic acid and salts thereof, and optionally silicotungstic acid (H₄SiW₁₂O₄₀) and salts thereof. The sources of tungsten can also be any heteropolycompound of Keggin, lacunary Keggin, substituted Keggin or Dawson type, for example. Use is preferably made of the oxides and the ammonium salts, such as ammonium metatungstate, or the heteropolyanions of Keggin, lacunary Keggin or substituted Keggin type.

The cobalt precursors which can be used are advantageously chosen from the oxides, hydroxides, hydroxycarbonates, carbonates and nitrates, for example. Use is preferably made of cobalt hydroxide and cobalt carbonate.

The nickel precursors which can be used are advantageously chosen from the oxides, hydroxides, hydroxycarbonates, carbonates and nitrates, for example. Use is preferably made of nickel hydroxide and nickel hydroxycarbonate.

In this case, the (group VIII metal)/(group VIB metal) molar ratio is generally between 0.1 and 0.8, preferably between 0.15 and 0.6.

It is also possible to introduce phosphorus into the impregnation solution.

The preferred phosphorus precursor is orthophosphoric acid H₃PO₄ but its salts and esters, such as ammonium phosphates, are also suitable. The phosphorus can also be introduced at the same time as the group VIB metal(s) in the form of Keggin, lacunary Keggin, substituted Keggin or Strandberg-type heteropolyanions.

In this case, the molar ratio of the phosphorus added per group VIB metal is between 0.1 and 2.5 mol/mol, preferably between 0.1 and 2.0 mol/mol and more preferably still between 0.1 and 1.0 mol/mol.

It is also possible to introduce an organic compound comprising oxygen and/or nitrogen and/or sulfur into the impregnation solution.

The function of the additives or organic compounds is to increase the catalytic activity in comparison with the catalysts without additives. Said organic compound is preferentially impregnated on said catalyst after dissolution in aqueous or nonaqueous solution. Generally, the organic compound is chosen from a compound including one or more chemical functions chosen from carboxylic, alcohol, thiol, thioether, sulfone, sulfoxide, ether, aldehyde, ketone, ester, carbonate, amine, nitrile, imide, oxime, urea and amide functions or else compounds including a furan ring or else sugars.

The oxygen-containing organic compound may be one or more chosen from compounds comprising one or more chemical functions chosen from a carboxyl, alcohol, ether, aldehyde, ketone, ester or carbonate function or else compounds including a furan ring or else sugars. By way of example, the oxygen-containing organic compound can be one or more chosen from the group consisting of ethylene glycol, diethylene glycol, triethylene glycol, a polyethylene glycol (with a molecular weight of between 200 and 1500 g/mol), propylene glycol, 2-butoxyethanol, 2-(2-butoxyethoxy)ethanol, 2-(2-methoxyethoxy)ethanol, triethylene glycol dimethyl ether, glycerol, acetophenone, 2,4-pentanedione, pentanone, acetic acid, maleic acid, malic acid, malonic acid, oxalic acid, gluconic acid, tartaric acid, citric acid, γ-ketovaleric acid, a di(C₁-C₄ alkyl) succinate and more particularly dimethyl succinate, methyl acetoacetate, ethyl acetoacetate, 2-methoxyethyl 3-oxobutanoate, 2-methacryloyloxyethyl 3-oxobutanoate, dibenzofuran, a crown ether, orthophthalic acid, glucose, fructose, sucrose, sorbitol, xylitol, γ-valerolactone, 2-acetylbutyrolactone, propylene carbonate, 2-furaldehyde (also known as furfural), 5-hydroxymethylfurfural (also known as 5-(hydroxymethyl)-2-furaldehyde or 5-HMF), 2-acetylfuran, 5-methyl-2-furaldehyde, methyl 2-furoate, furfuryl alcohol (also known as furfuranol), furfuryl acetate, ascorbic acid, butyl lactate, butyl butyryllactate, ethyl 3-hydroxybutanoate, ethyl 3-ethoxypropanoate, methyl 3-methoxypropanoate, 2-ethoxyethyl acetate, 2-butoxyethyl acetate, 2-hydroxyethyl acrylate, 2-hydroxyethyl methacrylate and 5-methyl-2(3H)-furanone.

The nitrogen-containing organic compound can be one or more chosen from compounds comprising one or more chemical functions chosen from an amine or nitrile function. By way of example, the nitrogen-containing organic compound can be one or more chosen from the group consisting of ethylenediamine, diethylenetriamine, hexamethylenediamine, triethylenetetramine, tetraethylenepentamine, pentaethylenehexamine, acetonitrile, octylamine, guanidine and a carbazole.

The oxygen- and nitrogen-containing organic compound can be one or more chosen from compounds comprising one or more chemical functions chosen from a carboxylic acid, alcohol, ether, aldehyde, ketone, ester, carbonate, amine, nitrile, imide, amide, urea or oxime function. By way of example, the oxygen- and nitrogen-containing organic compound can be one or more chosen from the group consisting of 1,2-cyclohexanediaminetetraacetic acid, monoethanolamine (MEA), 1-methyl-2-pyrrolidinone, dimethylformamide, ethylenediaminetetraacetic acid (EDTA), alanine, glycine, nitrilotriacetic acid (NTA), N-(2-hydroxyethyl)ethylenediamine-N,N′,N′-triacetic acid (HEDTA), diethylenetriaminepentaacetic acid (DTPA), tetramethylurea, glutamic acid, dimethylglyoxime, bicine, tricine, 2-methoxyethyl cyanoacetate, 1-ethyl-2-pyrrolidinone, 1-vinyl-2-pyrrolidinone, 1,3-dimethyl-2-imidazolidinone, 1-(2-hydroxyethyl)-2-pyrrolidinone, 1-(2-hydroxyethyl)-2,5-pyrrolidinedione, 1-methyl-2-piperidinone, 1-acetyl-2-azepanone, 1-vinyl-2-azepanone and 4-aminobutanoic acid.

The sulfur-containing organic compound can be one or more chosen from compounds comprising one or more chemical functions chosen from a thiol, thioether, sulfone or sulfoxide function. By way of example, the sulfur-containing organic compound can be one or more chosen from the group consisting of thioglycolic acid, 2,2′-thiodiethanol, 2-hydroxy-4-methylthiobutanoic acid, a sulfone derivative of a benzothiophene or a sulfoxide derivative of a benzothiophene, methyl 3-(methylthio)propanoate and ethyl 3-(methylthio)propanoate.

Preferably, the organic compound contains oxygen; preferably, it is chosen from γ-valerolactone, 2-acetylbutyrolactone, triethylene glycol, diethylene glycol, ethylene glycol, ethylenediaminetetraacetic acid (EDTA), maleic acid, malonic acid, citric acid, gluconic acid, dimethyl succinate, glucose, fructose, sucrose, sorbitol, xylitol, γ-ketovaleric acid, dimethylformamide, 1-methyl-2-pyrrolidinone, propylene carbonate, 2-methoxyethyl 3-oxobutanoate, bicine, tricine, 2-furaldehyde (also known as furfural), 5-hydroxymethylfurfural (also known as 5-(hydroxymethyl)-2-furaldehyde or 5-HMF), 2-acetylfuran, 5-methyl-2-furaldehyde, ascorbic acid, butyl lactate, ethyl 3-hydroxybutanoate, ethyl 3-ethoxypropanoate, 2-ethoxyethyl acetate, 2-butoxyethyl acetate, 2-hydroxyethyl acrylate, 1-vinyl-2-pyrrolidinone, 1,3-dimethyl-2-imidazolidinone, 1-(2-hydroxyethyl)-2-pyrrolidinone, 1-(2-hydroxyethyl)-2,5-pyrrolidinedione, 5-methyl-2(3H)-furanone, 1-methyl-2-piperidinone and 4-aminobutanoic acid.

In this case, the molar ratio of the organic compound added per group VIB metal is between 0.01 and 5 mol/mol, preferably between 0.05 and 3 mol/mol, preferably between 0.05 and 2 mol/mol and very preferably between 0.1 and 1.5 mol/mol.

When several organic compounds are present, the various molar ratios apply for each of the organic compounds present.

The impregnation step using an impregnation solution and in which said material is brought into contact with an impregnation solution comprising a group VIB metal and/or a group VIII metal and/or phosphorus and/or an organic compound comprising oxygen and/or nitrogen and/or sulfur may be carried out either by excess impregnation or by dry impregnation, or by any other means known to those skilled in the art.

Equilibrium (or excess) impregnation consists in immersing the support or the material in a volume of solution (often considerably) greater than the pore volume of the support or of the material while keeping the system stirred in order to improve the exchanges between the solution and the support or material. An equilibrium is finally reached after diffusion of the various entities into the pores of the support or material. Control of the amount of elements deposited is provided by the prior measurement of an adsorption isotherm which relates the concentration of the elements to be deposited contained in the solution to the amount of the elements deposited on the solid in equilibrium with this solution.

Dry impregnation consists, for its part, in introducing a volume of impregnation solution equal to the pore volume of the support or of the material. Dry impregnation makes it possible to deposit, on a given support or material, all of the metals and additives contained in the impregnation solution.

Any impregnation solution described above may comprise any polar protic solvent known to those skilled in the art. Preferably, use is made of a polar protic solvent, for example chosen from the group formed by methanol, ethanol and water. Preferably, the impregnation solution comprises a water-ethanol or water-methanol mixture as solvents in order to facilitate the impregnation of the compound containing a group VIB metal (and optionally of the compound containing a group VIII metal and/or of the phosphorus and/or of the organic compound) on the catalyst. Preferably, the solvent used in the impregnation solution consists of water or a water-ethanol or water-methanol mixture.

In one possible embodiment, the solvent can be absent from the impregnation solution. In this case, the phosphoric acid also acts as a solvent.

The impregnation step using an impregnation solution may advantageously be carried out by one or more excess impregnations of solution or preferably by one or more dry impregnations and very preferably by a single dry impregnation of said catalyst, using the impregnation solution.

The impregnation step using an impregnation solution comprises several embodiments. They are distinguished in particular by the moment of the introduction of the organic compound when it is present and which can be carried out either at the same time as the impregnation of the compound comprising a group VIII metal (co-impregnation), or after (post-impregnation), or before (pre-impregnation). In addition, it is possible to combine the embodiments. Preferably, a coimpregnation is carried out.

Advantageously, after each impregnation step, the impregnated support is left to mature. Maturation enables the impregnation solution to homogeneously disperse within the support or material.

Any maturation step described in the present invention is advantageously carried out at atmospheric pressure, in a water-saturated atmosphere and at a temperature of between 17° C. and 50° C., and preferably at room temperature. Generally, a maturation time of between ten minutes and forty-eight hours and preferably of between thirty minutes and six hours is sufficient.

When several impregnation steps are performed, each impregnation step is preferably followed by an intermediate drying step at a temperature below 200° C., advantageously between 100° C. and less than 200° C., preferably between 50° C. and 180° C., more preferably between 70° C. and 150° C., very preferably between 75° C. and 130° C. Optionally, a maturation period was observed between the impregnation step and the intermediate drying step. In addition, a calcining step may be carried out following the drying step, at a temperature of between 200° C. and 600° C., preferably of between 250° C. and 550° C., in an inert atmosphere (nitrogen for example).

### Impregnation Step Using an Impregnation Solution Via Pre-Impregnation (Optional)

According to another variant, it may be advantageous in certain cases to add to the electrically conductive support, before step a) of the process according to the invention, at least one of the additional metal precursors and/or phosphorus and/or an organic compound by impregnation using an impregnation solution (conventional pre-impregnation).

This conventional impregnation step has the advantage of being able to use metal precursors or organic compounds which are not accessible via the melt technique (because they are in liquid form or have too high a melting point).

Thus, according to one variant, step a) of bringing water into contact with the electrically conductive support may be preceded by an impregnation step using an impregnation solution and in which said support is brought into contact with an impregnation solution comprising a group VIB metal and/or a group VIII metal and/or phosphorus and/or an organic compound comprising oxygen and/or nitrogen and/or sulfur.

The pre-impregnation step can be carried out in the same way as the post-impregnation step described above. It generally comprises at least one impregnation step, followed by drying and optionally calcination as described for the post-impregnation step.

This pre-impregnation step is notably advantageous when it is desired to introduce an organic compound having a melting point above 100° C.

Among the organic compounds comprising oxygen and/or nitrogen and/or sulfur and having a melting point above 100° C., malonic acid, citric acid, gluconic acid, glucose, fructose, 2-methoxyethyl 3-oxobutanoate or 5-methyl-2-furaldehyde will preferably be chosen.

In this case, the molar ratio of the organic compound added per group VIB metal present in the material introduced subsequently via melt impregnation and optionally supplemented by a pre- or post-impregnation is between 0.01 and 5 mol/mol, preferably between 0.05 and 3 mol/mol, preferably between 0.05 and 2 mol/mol and very preferably between 0.1 and 1.5 mol/mol.

When several organic compounds are present, the various molar ratios apply for each of the organic compounds present.

When an organic compound is present, the material is preferably not subjected to a calcination.

### Sulfurization Step d)

The sulfurization carried out during step d) is intended to at least partially sulfurize the group VIB metal and optionally at least partially sulfurize the group VIII metal when it is present.

The sulfurization step d) can advantageously be carried out using an H₂S/H₂ or H₂S/N₂ gas mixture containing at least 5% by volume of H₂S in the mixture or under a flow of pure H₂S at a temperature of between 100° C. and 600° C. It is generally carried out under a total pressure equal to or greater than 0.1 MPa, generally for at least 2 hours.

Preferably, when the precursor of the catalytic material comprises the metals from groups VIB and VIII, the sulfurization temperature is between 350° C. and 550° C.

Preferably, when the precursor of the catalytic material comprises only group VIB metals, the sulfurization temperature is between 100° C. and 250° C. or between 400° C. and 600° C.

### Catalytic Material

The catalytic material resulting from the preparation process according to the invention comprises at least one electrically conductive support and at least one group VIB metal in sulfide form.

The support for the catalytic material is a support comprising at least one electrically conductive material. According to one variant, the support consists of an electrically conductive material.

In one embodiment according to the invention, the support for the catalytic material comprises at least one material chosen from carbon structures of carbon black, graphite, carbon nanotubes or graphene type.

In one embodiment according to the invention, the support for the catalytic material comprises at least one material chosen from gold, copper, silver, titanium or silicon.

A porous and nonelectrically-conductive material can be rendered electrically conductive by depositing an electrically conductive material at the surface thereof; mention may be made, for example, of a refractory oxide, such as an alumina, within which graphitic carbon is deposited.

The support for the catalytic material advantageously exhibits a BET specific surface (SS) of greater than 75 m²/g, preferably of greater than 100 m²/g, very preferably of greater than 130 m²/g.

The electrically conductive support has a water uptake volume or WUV of between 0.2 and 8 cm³·g⁻¹, preferably between 0.5 and 2 cm³·g⁻¹. The retention volume is determined in the following manner: deionized water is run dropwise, using a graduated burette, onto a known mass of support, placed in a pan rotated using a motor, while the support is manually mixed using a spatula. When the support begins to adhere to the wall of the pan, the dropwise addition is halted and the volume of water used is noted. The volume of water/mass of support ratio is then calculated, the water uptake volume (WUV) being expressed in cm³/g.

The activity of the catalytic material, notably for the production of hydrogen by electrolysis of water, is ensured by an element from group VIB and optionally by at least one element from group VIII. Advantageously, the active phase is chosen from the group formed by the combinations of the elements nickel-molybdenum or cobalt-molybdenum or nickel-cobalt-molybdenum or nickel-tungsten or nickel-molybdenum-tungsten.

The total content of group VIB metal (introduced by the metallic acid hydrate and optionally supplemented by an impregnation using an impregnation solution comprising a group VIB metal in pre- or post-impregnation) present in the catalytic material is between 4% and 70% by weight of group VIB metal element relative to the weight of the final catalytic material obtained after the last preparation step, i.e. the sulfurization.

When the group VIB metal is molybdenum, the total content of molybdenum (Mo) is between 4% and 60% by weight of Mo element relative to the weight of the final catalytic material, and preferably between 7% and 50% by weight relative to the weight of the final catalytic material obtained after the last preparation step, i.e. the sulfurization.

When the group VIB metal is tungsten, the total content of tungsten (W) is between 7% and 70% by weight of W element relative to the weight of the final catalytic material, and preferably between 12% and 60% by weight relative to the weight of the final catalytic material obtained after the last preparation step, i.e. the sulfurization.

The surface density, which corresponds to the amount of molybdenum Mo atoms deposited per unit area of support, will advantageously be between 0.5 and 20 atoms of Mo per square nanometer of support and preferably between 2 and 15 atoms of Mo per square nanometer of support.

When the catalytic material comprises at least one group VIII metal, the total content of group VIII metal (introduced by the metal salt hydrate and optionally supplemented by an impregnation using an impregnation solution comprising a group VIII metal in pre- or post-impregnation) is advantageously between 0.1% and 15% by weight of group VIII element, preferably between 0.5% and 10% by weight relative to the total weight of the final catalytic material obtained after the last preparation step, i.e. the sulfurization.

Optionally, the catalytic material may also have a total content of phosphorus (introduced by phosphoric acid by melt impregnation or by an impregnation using an impregnation solution comprising phosphoric acid) present in the catalytic material generally of between 0.1% and 20% by weight of P₂O₅ relative to the total weight of catalyst, preferably between 0.2% and 15% by weight of P₂O₅, very preferably between 0.3% and 11% by weight of P₂O₅. For example, the phosphorus present in the catalytic material is combined with the group VIB metal and optionally also with the group VIII metal in the form of heteropolyanions.

Furthermore, the phosphorus/(group VIB metal) molar ratio is generally between 0.08 and 1, preferably between 0.1 and 0.9 and very preferably between 0.15 and 0.8.

The content of phosphorus in the catalytic material is expressed as oxides after correction for the loss on ignition of the sample of catalytic material at 550° C. in a muffle furnace for two hours. The loss on ignition is due to the loss of moisture. It is determined according to ASTM D7348.

The catalytic material advantageously exhibits a BET specific surface (SS) of greater than 75 m²/g, preferably of greater than 100 m²/g, very preferably of greater than 130 m²/g.

### Electrode

The catalytic material obtained by the preparation process according to the invention can be used as electrode catalytic material capable of being used for electrochemical reactions, and in particular for the electrolysis of water in a liquid electrolytic medium. Advantageously, the electrode comprises a catalytic material obtained by the preparation process according to the invention and a binder.

The binder is preferably a polymer binder chosen for its capacities to be deposited in the form of a layer of variable thickness and for its capacities for ionic conduction in an aqueous medium and for diffusion of dissolved gases. The layer of variable thickness, advantageously of between 1 and 500 μm, in particular of the order of 10 to 100 μm, can in particular be a gel or a film.

Advantageously, the ionic conductive polymer binder is:
either conductive of anionic groups, in particular of hydroxy group, and is chosen from the group comprising in particular:
polymers stable in an aqueous medium, which can be perfluorinated, partially fluorinated or nonfluorinated and which have cationic groups enabling the conduction of hydroxide anions, said cationic groups being of quaternary ammonium, guanidinium, imidazolium, phosphonium, pyridium or sulfide type;
ungrafted polybenzimidazole;
chitosan; and
mixtures of polymers comprising at least one of the various polymers mentioned above, said mixture having anionic conductive properties;
or conductive of cationic groups enabling the conduction of protons and is chosen from the group comprising in particular:
polymers which are stable in an aqueous medium, which can be perfluorinated, partially fluorinated or nonfluorinated and which have anionic groups enabling the conduction of protons;
grafted polybenzimidazole;
chitosan; and
mixtures of polymers comprising at least one of the various polymers mentioned above, said mixture having cationic conductive properties.

Mention may in particular be made, among the polymers which are stable in an aqueous medium and which have cationic groups enabling the conduction of anions, of polymer chains of perfluorinated type, such as, for example, polytetrafluoroethylene (PTFE), of partially fluorinated type, such as, for example, polyvinylidene fluoride (PVDF), or of nonfluorinated type, such as polyethylene, which will be grafted with anionic conductive molecular groups.

Among the polymers which are stable in an aqueous medium and which have anionic groups enabling the conduction of protons, consideration may be given to any polymer chain stable in an aqueous medium containing groups such as —SO₃⁻, —COO⁻, —PO₃²⁻, —PO₃H⁻ or —C₆H₄O⁻. Mention may in particular be made of Nafion®, sulfonated and phosphonated polybenzimidazole (PBI), sulfonated or phosphonated polyetheretherketone (PEEK).

In accordance with the present invention, any mixture comprising at least two polymers, one at least of which is chosen from the groups of polymers mentioned above, can be used, provided that the final mixture is ionic conductive in an aqueous medium. Thus, mention may be made, by way of example, of a mixture comprising a polymer stable in an alkaline medium and having cationic groups enabling the conduction of hydroxide anions with a polyethylene not grafted by anionic conductive molecular groups, provided that this final mixture is anionic conductive in an alkaline medium. Mention may also be made, by way of example, of a mixture of a polymer stable in an acidic or alkaline medium and having anionic or cationic groups enabling the conduction of protons or hydroxides and of grafted or ungrafted polybenzimidazole.

Advantageously, polybenzimidazole (PBI) is used in the present invention as binder. It is not intrinsically a good ionic conductor but, in an alkaline or acidic medium, it proves to be an excellent polyelectrolyte with respectively very good anionic or cationic conduction properties. PBI is a polymer generally used, in the grafted form, in the manufacture of proton conductive membranes for fuel cells, in membrane-electrode assemblies and in PEM-type electrolyzers, as an alternative to Nafion®. In these applications, the PBI is generally functionalized/grafted, for example by a sulfonation, in order to render it proton conductive. The role of PBI in this type of system is then different from that which it has in the manufacture of the electrodes according to the present invention, where it is used only as binder and has no direct role in the electrochemical reaction.

Even if its long-term stability in a concentrated acid medium is limited, chitosan, which can also be used as an anionic or cationic conductive polymer, is a polysaccharide exhibiting ionic conduction properties in a basic medium which are similar to those of PBI (G. Couture, A. Alaaeddine, F. Boschet and B. Ameduri, Progress in Polymer Science, 36 (2011), 1521-1557).

Advantageously, the electrode according to the invention is formulated by a process which additionally comprises a step of removal of the solvent at the same time as or after step 3). Removal of the solvent can be carried out by any technique known to those skilled in the art, notably by evaporation or phase inversion.

In the case of evaporation, the solvent is an organic or inorganic solvent, the evaporation temperature of which is below the decomposition temperature of the polymer binder used. Mention may be made, as examples, of dimethyl sulfoxide (DMSO) or acetic acid. A person skilled in the art is capable of choosing the organic or inorganic solvent suitable for the polymer or for the polymer mixture used as binder and capable of being evaporated.

According to a preferred embodiment of the invention, the electrode is able to be used for the electrolysis of water in an alkaline liquid electrolyte medium and the polymer binder is then an anionic conductor in an alkaline liquid electrolyte medium, in particular a conductor of hydroxides.

Within the meaning of the present invention, alkaline liquid electrolyte medium is understood to mean a medium, the pH of which is greater than 7, advantageously greater than 10.

The binder is advantageously conductive of hydroxides in an alkaline medium. It is chemically stable in electrolysis baths and has the capacity to diffuse and/or transport the OH⁻ ions involved in the electrochemical reaction to the surface of the particles, which are sites of redox reactions for the production of H₂ and O₂ gases. Thus, a surface which is not in direct contact with the electrolyte is all the same involved in the electrolysis reaction, a key point in the effectiveness of the system. The binder chosen and the shaping of the electrode do not hinder the diffusion of the gases formed and limit their adsorption, thus making possible their discharge. According to another preferred embodiment of the invention, the electrode is capable of being used for the electrolysis of water in an acidic liquid electrolyte medium and the polymer binder is a cationic conductor in an acidic liquid electrolyte medium, in particular conductive of protons.

Within the meaning of the present invention, acidic medium is understood to mean a medium, the pH of which is less than 7, advantageously less than 2.

Those skilled in the art, in the light of their general knowledge, will be capable of defining the amounts of each component of the electrode. The density of the particles of catalytic material must be sufficient to reach their electrical percolation threshold.

According to a preferred embodiment of the invention, the polymer binder/catalytic material ratio by weight is between 5/95 and 95/5, preferably between 10/90 and 90/10 and more preferentially between 10/90 and 40/60.

### Process for the Preparation of the Electrode

The electrode can be prepared according to techniques well known to a person skilled in the art. More particularly, the electrode is formulated by a preparation process comprising the following steps:

1) dissolving at least one ionic conductive polymer binder in a solvent or a solvent mixture;
2) adding at least one catalytic material prepared according to the invention, in powder form, to the solution obtained in step 1) in order to obtain a mixture;
steps 1) and 2) being carried out in any order or simultaneously;
3) depositing the mixture obtained in step 2) on a metallic or metallic-type conductive support or collector.

Within the meaning of the invention, catalytic material powder is understood to mean a powder consisting of particles of micron, submicron or nanometer size. The powders can be prepared by techniques known to a person skilled in the art.

Within the meaning of the invention, metallic-type support or collector is understood to mean any conductive material having the same conduction properties as metals, for example graphite or certain conductive polymers, such as polyaniline and polythiophene. This support can have any shape that enables the deposition of the mixture obtained (between the binder and the catalytic material) by a method chosen from the group comprising in particular dip coating, printing, induction, pressing, coating, spin coating, filtration, vacuum deposition, spray deposition, casting, extrusion or laminating. Said support or said collector can be solid or perforated. Mention may be made, as an example of a support, of a grid (perforated support) or a plate or a sheet of stainless steel (304L or 316L, for example) (solid supports).

The advantage of the mixture according to the invention is that it can be deposited on a solid or perforated collector, by the usual easily accessible deposition techniques which enable deposition in the forms of layers of variable thicknesses, ideally of the order of from 10 to 100 μm.

In accordance with the invention, the mixture can be prepared by any technique known to a person skilled in the art, in particular by mixing the binder and the at least one catalytic material in powder form in a solvent or a mixture of solvents suitable for obtaining a mixture with the rheological properties enabling the deposition of the electrode materials in the form of a film of controlled thickness on an electron conductive substrate. The use of the catalytic material in powder form enables maximization of the surface area developed by the electrodes and enhancement of the associated performance qualities. Those skilled in the art will be able to make the choices of the various formulation parameters in the light of their general knowledge and of the physicochemical characteristics of said mixtures.

### Operating Processes

Another subject according to the invention relates to an electrolysis device comprising an anode, a cathode and an electrolyte, in which at least one of the anode or of the cathode is an electrode according to the invention.

The electrolysis device can be used as a water electrolysis device for the production of a gaseous mixture of hydrogen and oxygen and/or the production of hydrogen alone comprising an anode, a cathode and an electrolyte, said device being characterized in that one at least of the cathode or of the anode is an electrode according to the invention, preferably the cathode. The electrolysis device consists of two electrodes (an anode and a cathode, which are electron conductors) connected to a direct current generator and separated by an electrolyte (ionic conductive medium). The anode is the site of the oxidation of the water. The cathode is the site of the reduction of the protons and the formation of hydrogen.

The electrolyte can be:
either an acidic (H₂SO₄ or HCl, and the like) or basic (KOH) aqueous solution;
or a proton exchange polymer membrane which ensures the transfer of the protons from the anode to the cathode and enables the separation of the anode and cathode compartments, which prevents the entities reduced at the cathode from reoxidizing at the anode, and vice versa;
or a ceramic membrane conductive of O₂⁻ ions. Reference is then made to a solid oxide electrolysis (SOEC or Solid Oxide Electrolyzer Cell).

The minimum water supply of an electrolysis device is 0.8 l/Sm³ of hydrogen. In practice, the actual value is close to 1 l/Sm³. The water introduced must be as pure as possible because the impurities remain in the equipment and accumulate over the course of the electrolysis, ultimately disrupting the electrolytic reactions by:
the formation of sludges; and by
the action of chlorides on the electrodes.

An important specification with regard to the water relates to its ionic conductivity (which must be less than a few μS/cm).

There are many suppliers offering very diversified technologies, in particular in terms of the nature of the electrolyte and of associated technology, ranging from a possible upstream coupling with a renewable electricity supply (photovoltaic or wind power) to the direct final provision of pressurized hydrogen.

The reaction has a standard potential of −1.23 V, which means that it ideally requires a potential difference between the anode and the cathode of 1.23 V. A standard cell usually operates under a potential difference of 1.5 V and at room temperature. Some systems can operate at higher temperature. This is because it has been shown that high temperature electrolysis (HTE) is more efficient than the electrolysis of water at room temperature, on the one hand because a portion of the energy required for the reaction can be contributed by the heat (cheaper than electricity) and, on the other hand, because the activation of the reaction is more efficient at high temperature. HTE systems generally operate between 100° C. and 850° C.

The electrolysis device can be used as a nitrogen electrolysis device for the production of ammonia, comprising an anode, a cathode and an electrolyte, said device being characterized in that one at least of the cathode or of the anode is an electrode according to the invention, preferably the cathode.

The electrolysis device consists of two electrodes (an anode and a cathode, which are electron conductors) connected to a direct current generator and separated by an electrolyte (ionic conductive medium). The anode is the site of the oxidation of the water. The cathode is the site of the nitrogen reduction and the ammonia formation. Nitrogen is continuously injected into the cathode compartment.

The nitrogen reduction reaction is:

N₂+6H⁺+6e⁻→2NH₃

The electrolyte can be:
either an aqueous solution (Na₂SO₄ or HCl), preferably saturated with nitrogen;
or a proton exchange polymer membrane which ensures the transfer of the protons from the anode to the cathode and enables the separation of the anode and cathode compartments, which prevents the entities reduced at the cathode from reoxidizing at the anode, and vice versa.

The electrolysis device can be used as a carbon dioxide electrolysis device for the production of formic acid, comprising an anode, a cathode and an electrolyte, said device being characterized in that one at least of the cathode or of the anode is an electrode according to the invention. An example of anode and of electrolyte which can be used in such a device is described in detail in the document FR 3 007 427.

The electrolysis device can be used as a fuel cell device for the production of electricity from hydrogen and oxygen comprising an anode, a cathode and an electrolyte (liquid or solid), said device being characterized in that one at least of the cathode or of the anode is an electrode according to the invention.

The fuel cell device consists of two electrodes (an anode and a cathode, which are electron conductors) which are connected to a charge C for delivering the electric current produced and which are separated by an electrolyte (ionic conductive medium). The anode is the site of the oxidation of the hydrogen. The cathode is the site of the reduction of the oxygen.

The electrolyte can be:
either an acidic (H₂SO₄ or HCl, and the like) or basic (KOH) aqueous solution;
or a proton exchange polymer membrane which ensures the transfer of the protons from the anode to the cathode and enables the separation of the anode and cathode compartments, which prevents the entities reduced at the cathode from reoxidizing at the anode, and vice versa;
or a ceramic membrane conductive of O₂⁻ ions. Reference is then made to a solid oxide fuel cell (SOFC).

The following examples illustrate the present invention. The examples below relate to the electrolysis of water in a liquid electrolytic medium for the production of hydrogen.

### EXAMPLES

### Example 1: Preparation of a Catalytic Material C1 (not in Accordance with the Invention) from H₃PMo₁₂O₄₀.28H₂O and Ni(NO₃)₂.6H₂O in Ethanol

The catalytic material C1 (in accordance with the invention) is prepared by dry impregnation of 10 g of commercial carbon-type support (Ketjenblack®, 1400 m²/g) with 26 ml of solution. The solution is obtained by dissolving, in water, H₃PMo₁₂O₄₀ at a concentration of 2.6 mol/l and Ni(NO₃)₂.6H₂O such that the Ni/Mo ratio=0.2. The support is impregnated by carrying out a dropwise addition of the volume of the solution, while rotating in a pan. The precatalyst is then matured for 4 h (maturing chamber filled with ethanol), then dried under an inert atmosphere and at reduced pressure (while drawing under vacuum) at 60° C. (oil bath) using a rotary evaporator for 2 h. The precatalyst is then sulfurized under pure H₂S at a temperature of 400° C. for 2 hours under 0.1 MPa (1 bar) of pressure.

On the final catalyst, the amount of Mo corresponds to a surface density of 7 atoms per nm² and the Ni and P ratios are respectively: Ni/Mo=0.2 and P/Mo=0.08.

### Example 2: Preparation of a Melt-Impregnated Catalytic Material C2 (in Accordance with the Invention) from H₃PMo₁₂O₄₀.28H₂O and Ni(NO₃)₂.6H₂O

The catalytic material C2 (in accordance with the invention) is prepared by melt impregnation of 10 g of commercial carbon-type support (Ketjenblack®, 1400 m²/g). The support is pre-impregnated with 10 ml of water, i.e. 38% of the WUV. In order to allow the support to be correctly impregnated, it is placed in a maturing chamber for 1 h. The support pre-impregnated with water is then transferred to the reactor with the H₃PMo₁₂O₄₀.28H₂O (PMA) and Ni(NO₃)₂.6H₂O, the melting points of which are 85° C. and 56.7° C. respectively. Reflux is implemented and the reactor is heated at 85° C. with stirring for 3 h. The precatalyst is then left to mature for 18 h. The precatalyst is then sulfurized under pure H₂S at a temperature of 400° C. for 2 hours under 0.1 MPa (1 bar) of pressure.

On the final catalyst, the amount of Mo corresponds to a surface density of 7 atoms per nm² and the Ni and P ratios are respectively: Ni/Mo=0.2 and P/Mo=0.08.

### Example 3: Description of the Commercial Pt Catalyst (Catalyst C2)

The material C2 originates from Alfa Aesar®: it comprises platinum particles with a specific surface area S_{BET}=27 m²/g.

### Example 4: Catalytic Test

The characterization of the catalytic activity of the catalytic materials is carried out in a 3-electrode cell. This cell is composed of a working electrode, of a platinum counterelectrode and of an Hg/Hg₂SO₄ reference electrode. The electrolyte is a 0.5 mol/l aqueous solution of Suprapur sulfuric acid (H₂SO₄). Before the electrochemical measurements, the medium is deaerated by bubbling with argon for 30 minutes then hydrogen bubbling is carried out for 15 minutes to be at H₂ saturation. An H₂ overhead is generated throughout the duration of the measurements.

The working electrode consists of a disk of glassy carbon with a diameter of 5 mm set in a removable Teflon tip (rotating disk electrode). Glassy carbon has the advantage of having no catalytic activity and of being a very good electrical conductor. In order to deposit the catalysts (C1, C2 and C3) on the electrode, a catalytic ink is formulated.

The glassy carbon tip is polished with 3 μm then 1 μm diamond paste between each test then washed ultrasonically according to the following program: 15 minutes acetone, 15 minutes EtOH+ultra pure water, 15 minutes ultra pure water then drying in an oven at 110° C. for 10 minutes.

This ink consists of a binder in the form of a solution of 27 μl of 15 wt % Nafion®, of a solvent (0.41 ml of ultra pure water+1.29 ml of propan-1-ol) and of 10 mg of catalyst (C1, C2, C3) ground with a pestle in a mortar. The role of the binder is to ensure the cohesion of the particles of the supported catalyst and the adhesion to the glassy carbon. This ink is then placed in an ultrasonic bath for 45 minutes in order to obtain a good dissolution of the preground catalytic ink and to homogenize the mixture. 10 μl of the prepared ink are deposited on the glassy carbon tip (described above) preheated to 100° C. and rotated at 50 rpm then 500 rpm after depositing the drop to ensure a homogeneous deposit. A theoretical weight of 0.3 mg/cm² is thus obtained. The deposit is then dried in an oven for 20 minutes at 80° C. to evaporate the solvent.

Different electrochemical methods are used in order to determine the performance qualities of the catalysts:
linear voltammetry: it consists in applying, to the working electrode, a potential signal which varies with time, i.e. from 0 to −1.1 V vs RHE at a rate of 20 mV/s, and in measuring the faradaic response current, that is to say the current resulting from the oxidation-reduction reaction taking place at the working electrode. This method is ideal for determining the catalytic power of a material for a given reaction. It makes it possible, inter alia, to determine the overvoltage necessary for the reduction of the protons to give H₂.
chronopotentiometry: it consists, for its part, in applying a current or a current density for a predetermined time and in measuring the resulting potential. This study makes it possible to determine the catalytic activity at constant current but also the stability of the system over time. It is carried out with a current density of −10 mA/cm² and for a given time.

It will be noted that all the electrochemical tests are carried out with a speed of rotation of the working electrode of 3000 rpm. Chronoamperometry (measurement of the current at imposed potential) is carried out for 5 minutes prior to these tests in order to activate the deposit (formation of surface hydrides) and to overcome the bubbles of H₂ formed at the start of the reaction.

The catalytic performance qualities are collated in table 1 below. They are expressed as overvoltage at a current density of −10 mA/cm².

| | | | Overvoltage |
|---|---|---|---|
| | | | at −10 |
| | | Composition | mA/cm² |
| Catalytic material | preparation | based on | [(mV) vs RHE] |
| C1 | Dry | Mo | −190 |
| (not in accordance | impregnation | | |
| with the | | | |
| invention) | | | |
| C2 | Melt | Mo | −180 |
| (in accordance | impregnation | | |
| with the | | | |
| invention) | | | |
| Reference C3 | commercial | Pt | −90 |

With an overvoltage of only −180 mV vs RHE, the catalytic material C2 exhibits performance qualities relatively close to those of platinum. This result demonstrates the indisputable advantage of the material C2 for the development of the hydrogen sector by electrolysis of water. Compared to catalyst C1, catalyst C2 has slightly improved performance qualities, which reinforces the advantage of preparation by melt impregnation.

1. A process for preparing a catalytic material of an electrode for electrochemical reduction reactions, said material comprising an active phase based on at least one group VIB metal and an electrically conductive support, the content of group VIB metal being between 4% and 70% by weight expressed as group VIB metal element relative to the total weight of the catalytic material, said process comprising:
a) bringing water into contact with said electrically conductive support so as to obtain a wet electrically conductive support,
b) bringing said wet electrically conductive support into contact with at least one metallic acid hydrate comprising at least one group VIB metal, of which the melting point of said metallic acid hydrate is between 20° C. and 100° C., in order to form a solid mixture, the weight ratio of said metallic acid to said electrically conductive support being between 0.1 and 4,
c) heating, with stirring, the solid mixture obtained at the end of step b) to a temperature between the melting point of said metallic acid hydrate and 100° C., and
d) carrying out sulfurization of the material obtained at the end of c) at a temperature of between 100° C. and 600° C.

2. The process as claimed claim 1, wherein in b) the metallic acid hydrate is chosen from phosphomolybdic acid hydrate, silicomolybdic acid hydrate, molybdosilicic acid hydrate, phosphotungstic acid hydrate, and silicotungstic acid hydrate.

3. The process as claimed in claim 1, wherein the electrically conductive support comprises at least one material chosen from carbon structures of carbon black, graphite, carbon nanotubes, and graphene.

4. The process as claimed in claim 1, wherein the electrically conductive support comprises at least one material chosen from gold, copper, silver, titanium, and silicon.

5. The process as claimed in claim 1, wherein b) further comprises bringing said wet electrically conductive support into contact with at least one metal salt comprising at least one group VIII metal, of which the melting point of said metal salt is between 20° C. and 100° C., in order to form a solid mixture, the (group VIII metal)/(group VIB metal) molar ratio being between 0.1 and 0.8.

6. The process as claimed in claim 5, wherein said metal salt is a nitrate salt hydrate or a sulfate salt hydrate.

7. The process as claimed in claim 6, wherein said metal salt is chosen from nickel nitrate hexahydrate, cobalt nitrate hexahydrate, iron nitrate nonahydrate, nickel sulfate hexahydrate, cobalt sulfate heptahydrate, and iron sulfate heptahydrate, taken alone or as a mixture.

8. The process as claimed in claim 1, wherein b) further comprises bringing said wet electrically conductive support into contact with phosphoric acid, to form a solid mixture, the phosphorus/(group VIB metal) molar ratio being between 0.08 and 1.

9. The process as claimed in claim 1, wherein b) further comprises bringing said wet electrically conductive support into contact with an organic compound comprising oxygen and/or nitrogen and/or sulfur, of which the melting point of said organic compound is between 20° C. and 100° C., the organic compound/group VIB metal molar ratio being between 0.01 and 5.

10. The process as claimed in claim 9, wherein the organic compound is chosen from maleic acid, sorbitol, xylitol, γ-ketovaleric acid, 5-hydroxymethylfurfural and 1,3-dimethyl-2-imidazolidinone.

11. The process as claimed in claim 1, wherein, before a) or after c), an impregnation is carried out using an impregnation solution and wherein said electrically conductive support or said material obtained at the end of c) is brought into contact with an impregnation solution comprising a group VIB metal and/or a group VIII metal and/or phosphorus and/or an organic compound comprising oxygen and/or nitrogen and/or sulfur, followed by drying at a temperature below 200° C. and optionally calcining at a temperature above or equal to 200° C. and below or equal to 600° C. under an inert atmosphere.

12. The process as claimed in claim 11, wherein the organic compound is chosen from γ-valerolactone, 2-acetylbutyrolactone, triethylene glycol, diethylene glycol, ethylene glycol, ethylenediaminetetraacetic acid, maleic acid, malonic acid, citric acid, gluconic acid, dimethyl succinate, glucose, fructose, sucrose, sorbitol, xylitol, γ-ketovaleric acid, dimethylformamide, 1-methyl-2-pyrrolidinone, propylene carbonate, 2-methoxyethyl 3-oxobutanoate, bicine, tricine, 2-furaldehyde, 5-hydroxymethylfurfural, 2-acetylfuran, 5-methyl-2-furaldehyde, ascorbic acid, butyl lactate, ethyl 3-hydroxybutanoate, ethyl 3-ethoxypropanoate, 2-ethoxyethyl acetate, 2-butoxyethyl acetate, 2-hydroxyethyl acrylate, 1-vinyl-2-pyrrolidinone, 1,3-dimethyl-2-imidazolidinone, 1-(2-hydroxyethyl)-2-pyrrolidinone, 1-(2-hydroxyethyl)-2,5-pyrrolidinedione, 5-methyl-2(3H)-furanone, 1-methyl-2-piperidinone, and 4-aminobutanoic acid.

13. The process as claimed in claim 1, wherein, when the precursor of the catalytic material comprises at least one group VIB metal and at least one group VIII metal, the sulfurization temperature in d) is between 350° C. and 550° C.

14. The process as claimed in claim 1, wherein, when the precursor of the catalytic material comprises solely a group VIB metal, the sulfurization temperature in d) is between 100° C. and 250° C. or between 400° C. and 600° C.

15. An electrode formulated by a preparation process comprising:
1) dissolving at least one ionic conductive polymer binder in a solvent or a solvent mixture;
2) adding at least one catalytic material prepared as claimed claim 1, in powder form, to the solution obtained in 1) in order to obtain a mixture;
1) and 2) being carried out in any order or simultaneously; and
3) depositing the mixture obtained in 2) on a metallic or metallic-type conductive support or collector.

16. An electrolysis device comprising an anode, a cathode and an electrolyte, wherein at least of the anode or the cathode is an electrode as claimed in claim 15.

17. A method of performing an electrochemical reaction comprising performing said electrochemical reaction using the electrolysis device as claimed in claim 16.
